(19) United States
(12) Patent Application Publication
(10) Pub. No.: US 2005/0011653 A1
(43) Pub. Date: Jan. 20, 2005

(54) Process for extinguishment of underground coal seam fires

(76) Inventor: William M. Strabala, Arvada, CO (US)

Correspondence Address: SHERIDAN ROSS PC, 1560 BROADWAY, SUITE 1200, DENVER, CO, 80202, US

(21) Appl. No.: 10/887,170

(22) Filed: Jul. 7, 2004

Related U.S. Application Data
(60) Provisional application No. 60/488,038, filed on Jul. 16, 2003.

(51) Int. Cl. A62C 2/00

(52) U.S. Cl. 169/46; 169/64

(57) ABSTRACT

A process for extinguishments of underground coal seam fires employs the catalyst of heat generated by the underground fire to extinguish itself. A powdered limestone slurry provided in an aqueous mixture is injected from the surface in advance of the leading edge of the fire, such leading edge being previously detected, mapped and determined by the use of suitable technologies in order to guide the correct drilling of injection sites. The injection of a limestone slurry forms an underground “net” such that the heat of the coal fire, as it advances and comes into contact with the injected limestone plugs, expends energy in calcining the limestone, while also producing considerable amounts of carbon dioxide at the burning face of the fire, such carbon dioxide causing the self-extinguishment of such fires.

### RELATED APPLICATION

This application claims priority from U.S. Provisional Patent Application No. 60/488,038 filed on Jul. 16, 2003. The entire disclosure of the provisional application is considered to be part of the disclosure of the accompanying application and is hereby incorporated by reference

### FIELD OF THE INVENTION

The present invention is generally directed to the extinguishing of coal seam and/or petroleum fires using CO₂ generating materials and in particular, is directed to the use of powdered limestone slurries injected at the leading edge of coal seam fires such that the calcining of such limestone slurry by the fire creates effective amounts of carbon dioxide sufficient to extinguish some or all of the fire.

### BACKGROUND AND SUMMARY OF THE INVENTION

Most underground coal seam fires historically have been allowed to burn themselves to extinction for lack of a practical means to extinguish them. This has caused great harm to the environment and great economic harm by way of loss to energy assets. Any underground coal seam fire is difficult and expensive to extinguish by virtue of inaccessibility to the combustion face. A convenient means of accessing and suppressing that burning face without endangering public safety from a standpoint of exposure to poisonous gases or ground subsidence would be beneficial. The present invention affords a means of avoiding the above-referenced economical and environmental disasters.

In the suppression of fires in petrochemical masses such as underground coal, the use of familiar suppressants, such as water, is considered undesirable and is used only as a last-resort. This is because the use of water can cause pollutants from the fire to be transmitted to other strata or even to the surface, where potable water may exist. In addition, the extraction of water from a mine after the fire is smothered requires expensive beneficiation if the burned coal seam is to be rehabilitated for continued mining.

Because coal seam fires frequently cause surface subsidence and instability even under established communities, and are also accompanied by the release to the atmosphere of toxic gases, there are compelling reasons for the suppression of such fires for purely environmental reasons. At issue in any case is how to extinguish such a fire without causing equally serious harm to the environment from the process.

The present invention provides an environmentally friendly solution to such problems by reason of the application of unrelated techniques, sciences and chemical interactions, collectively, too obscure in their interrelationships as to make them obvious to most cognoscenti.

It is well known within the science of combustion and fire suppression that any process which separates oxygen from the fuel source (in this case underground coal) is an effective extinguisher. Carbon dioxide is such an accepted and useful extinguishing agent, especially prescribed for petrochemical fires. One aspect of the present invention is directed to a process for introducing carbon dioxide (e.g., as if from a fire extinguisher), to the underground level of the fire without significant hazard to man or the environment—in fact to the improvement of the environment. The present invention uses the catalyst of heat generated by the underground fire to extinguish itself.

Because no other extinguishment method in the mining industry uses the energy of the fire itself to cause its own suppression, the present invention teaches a new use of fire suppression under otherwise adverse conditions.

### PREFERRED EMBODIMENTS OF THE INVENTION

One aspect of the present invention is directed to the use of powdered limestone slurry in an aqueous mixture, used as a drilling mud for injection from the surface in advance of the leading edge of an underground coal seam fire, said leading edge to be detected, mapped and determined by use of infra-red aerial photography or other technology for the guidance of correct drilling sites. Limestone slurry injection sites form a kind of underground “net” so that the heat of the coal fire, as it advances and comes in contact with the injected limestone plugs, expends much of its energy in calcining the limestone. The calcining process produces great amounts of carbon dioxide at the burning face of the fire causing self-extinguishment.

As a process, the present invention relies preferably upon the use of aerial infrared photography to plot the horizontal parameters of the underground fire in order to facilitate the placement of “wells” to be drilled and filled with limestone slurry. The depth of such pluggable holes will vary depending upon the depth of the fire below the surface. For that reason, the placement and spacing of these wells, which preferably form a networked perimeter of limestone plugs or pickets, may also be guided by geological, mining and other technical experts and/or techniques to capture a 3-dimensional profile of the underground fire to be suppressed. This assists engineers in determining the course of the fire in order to “head it off” with one or more vertical columns of injected limestone.

Drilling is preferably conducted from the surface using conventional drilling rigs. In some situations allowance is made for the time and distance required to perform the task of creating a perimeter or “fence” of vertical limestone pickets in advance of the burning coal face. A CO₂ generating component (e.g., which is selected for its capacity to generate CO₂ when exposed to the type and degree of heat experienced near a coal/petroleum fire) preferably a limestone slurry, is preferably used as the “drilling mud” (a term known to the drilling industry). This limestone slurry is preferably left in place within the drilled shaft. Temperature excursions as measured in the circulated drilling mud may serve as a guide to the drilling contractors to know when they approach and then go deeper than the burning seam. The presence of coal ash in the drilling mud should indicate whether one is behind, instead of ahead, of the burning seam.

Note that, in describing the preferred embodiments, the use of limestone in a water slurry is in concert with natural environmental processes. Limestone is plentiful and harmless part of earth's existing geological background. It is also typically available in quantities present near most coal fires that require extinguishments. Carbon dioxide is essential to plant life. Water, of course, is a daily necessity to all life forms. Nothing significantly harmful to nature (e.g., toxic man-made fire extinguishing chemicals, etc.) is created as a byproduct of this process.

Properly plotted by the drilling, geological and mining experts on any project where this invention is applied, the result within the burning underground coal seam will be self-extinguishment by the heat energy of the fire itself as it impinges upon the limestone injections (e.g., pickets) and generates an overwhelming amount of carbon dioxide that preferably snuffs out the fire, or at least reduces the extent or degree thereof.

This process and methodology is especially adaptable to conditions where the coal seam fire has been active for many years and is not likely to burn itself out. It also works, however, on new fires that threaten to spread despite application of best suppression technologies known. The invention is quick acting, once the fire face comes into contact with the placement of the limestone.

While various embodiments of the present invention have been described in detail, it will be apparent that further modifications and adaptations of the invention will occur to those skilled in the art. It is to be expressly understood that such modifications and adaptations are within the spirit and scope of the present invention.

1. A method for extinguishing underground fires, comprising:
a) providing a quantity of CO₂ generating material in a form suitable for injecting into the ground;
b) determining a desired location above or adjacent to an underground fire;
c) drilling one or more suitable injection sites at said desired locations;
d) injecting said CO₂ generating material into the ground;
whereby said CO₂ generating material comes into contact with heat from said underground fire and undergoes a chemical reaction that releases CO₂ in amounts sufficient to reduce the degree of said underground fire.

2. The method as set forth in claim 1, wherein a plurality of injection sites are drilled.

3. The method as set forth in claim 1, wherein said CO₂ generating material comprises a powdered limestone slurry in an aqueous mixture.

4. The method as set forth in claim 1, wherein the amount of said CO₂ generating material is sufficient to entirely extinguish said underground fire.

5. The method as set forth in claim 1, wherein said CO₂ generating material consists essentially of powdered limestone slurry.

6. The method as set forth in claim 1, wherein said injection sites are located substantially only at a leading edge of said underground fire.

7. The method as set forth in claim 1, wherein said injection sites are selected so that the heat generated by said underground fire is sufficient to calcine said CO₂ generating material.

8. The method as set forth in claim 1, wherein said step of identifying injection sites comprises the use of aerial infra-red photography.

9. The method as set forth in claim 1, wherein additional fire extinguishing methods are used in conjunction with said method.

10. The method as set forth in claim 1, further comprising assaying drilling samples to determine suitable drilling locations.
